(19) United States
(12) Patent Application Publication
(10) Pub. No.: US 2020/0122993 A1
(43) Pub. Date: Apr. 23, 2020

(54) Automation System for Tracking Beverage Consumption

(71) Applicant: Elizabeth Marie De Zulueta, Miami, FL (US)

(72) Inventor: Elizabeth Marie De Zulueta, Miami, FL (US)

(73) Assignee: Elizabeth Marie De Zulueta, Miami, FL (US)

(21) Appl. No.: 16/658,624

(22) Filed: Oct. 21, 2019

Related U.S. Application Data
(60) Provisional application No. 62/748,566, filed on Oct. 22, 2018.

(51) Int. Cl. B67D 1/08; G01G 17/04; B67D 1/00

(52) U.S. Cl. CPC B67D 1/0888; B67D 1/0008; G01G 17/04

(57) ABSTRACT

An automation system for tracking beverage consumption and methods of its operation are provided herein. The automation system monitors the consumption of beverages with a focus on beverages, such as beer, cider and wine, that are housed in a barrel-like container such as a beer keg. The automation system consists of a sensor plate, cloud application service or local application services, communications services, real-time display, and integration with a mobile form factor. The sensor plate includes electronics, such as weight sensors, battery voltage sensors, and environmental sensors, as well as software to calculate the volume of the beverage based on data captured from the sensors and on-board algorithms. The cloud or local device will send and receive messages and their services will be utilized to parse and analyze the data captured by the sensor plate. The mobile form factor will then display to the user through a user interface the reports generated from the analyzed data. The real-time display will display current readings and calculations.

### CROSS REFERENCE TO RELATED APPLICATIONS

This application claims the benefit of U.S. Provisional Patent Application No. 62/748,566 filed on Oct. 22, 2018, the contents of which are incorporated herein by reference.

### FIELD OF THE INVENTION OR TECHNICAL FIELD

This invention relates generally to the field of automation and more specifically to an automation platform that can aid in the tracking and managing of beverages. The beverages that are monitored are those that are stored in a barrel type container such as a keg. The beverages can be beer, cider and wine but are not limited to these types of beverages.

### BACKGROUND OF THE INVENTION

Automation has been used in the manufacturing and packaging industry for decades, but the use of automation in the hospitality and beverage industry has been limited to task robots that perform cleaning functions such as pool cleaners and robotic vacuum cleaners and to automation systems that package the bottle beverages. The field of automation applied to hospitality and beverage management is new.

Today, in all bars, restaurants, and breweries across the country that have taps there are kegs and barrels that need to be monitored and changed. The current manner of tracking the keg is to wait until it pours only foam or to lift the keg and estimate the change in volume if the pouring of the beer slightly slows. This manner is neither simple nor precise, especially for bartenders with physical limitations which cannot lift the kegs or barrels. Such imprecision can contribute to the 20% of the beverage contained in the barrel being lost according to the beer industry.

In addition to the waste of the beverages, the lack of monitoring of beverages has an adverse effect in customer service. For instance, customers often must wait for a bartender with the physical capability to change out the keg. Kegs can weigh up to 165 pounds when filled to capacity. With a monitoring system and automation, establishments can detect and plan out changes. The establishments will be able to determine which beverages are most requested and consumed. With the high failure rate of restaurants and with the bar portion of the restaurant being the biggest source of revenue, establishments cannot afford any loss of revenue in their biggest generator. The establishments would also benefit from tools that would track which beverages are more consumed and assist in the planning, marketing and inventory of said beverages.

### BRIEF DESCRIPTION OF THE DRAWINGS

FIG. 1 Block diagram of beverage management system and cloud

FIG. 2 Block diagram of the beverage management system and local gateway or server

FIG. 3 Block diagram of cloud and local gateway and mobile form factor

FIG. 4 Block diagram of the sensor plate with a barrel and the real-time display

FIG. 5 Flow chart of software on the sensor plate

FIG. 6 Finite state diagram that models the event driven software system on the sensor plate

FIG. 7 Flow chart of software on the cloud application service and local gateway application service

FIG. 8 Screen of the user interface application on the mobile form factor

FIG. 9 Screen of the user interface application on the real-time display

### DETAILED DESCRIPTION AND BEST MODE OF IMPLEMENTATION

An automation system for tracking beverage consumption is a platform that monitors the consumption of beverages. In this case, the monitoring is focused on the beverages that are housed in a barrel-like container. This automation system consists of a platform with sensors which communicate its measurements, readings and alerts to a mobile form factor such as a tablet or mobile smartphone. The monitoring system can send its datasets to the cloud or a local server or a gateway device for disconnected environments. The monitoring system also offers a real-time display where a user, such as bartender, can obtain real-time data on the volume of the barrel. The automation system can handle barrels, such a keg, which weigh about 75 Kg or 165 lbs when filled to capacity.

The beverage tracking system is designed to aide establishments, such as restaurants and bars, in determining the rate at which beverages are being consumed and the rate and times that kegs should be changed out to minimize delays in service to the customer. This system would enable establishments to plan scheduling of employees, to coordinate marketing and promotions around identified popular beverages, to track inventory, and to reduce waste. In addition, another goal is to aide in improving customer service by ensuring that desirable beverages are available in a timely manner.

The automation system for tracking beverage consumption consists of a sensor plate with sensors and electronics, software that securely communicates to the cloud or local device, cloud and gateway services that aggregate the datasets from sensor plates from a given establishment, reporting services at the edge that reside on a mobile form factor such as smart phone or tablet, and local readouts so the user, such as the bartender, can see monitor the tap without having to carry an extra device. The local readouts are integrated at the user's discretion. The local device can connect to a gateway or local server. The local devices are designed for a disconnected environment. For instance, a cruise ship can be example of a disconnected environment that could leverage the local device offering.

The monitoring system is designed to calculate the volume of liquid that is in the barrel placed on the sensor plate. The automation system uses a non-intrusive method of determining the volume of the beverage. Using strain gauges and sensors, the system measures the weight of the barrel. The software will subtract the weight of an empty barrel from measured weight value. By using the density of the liquid, the volume can be ascertained from the measured weight and given density of the liquid. In addition to calculating volume in the barrel, the sensor plate is extensible and includes other sensors which would provide sensor readings such as battery voltage, humidity and temperature. The electronics on the sensor plate will use a battery as a source power. Establishments prefer the use of battery driven systems, but the electronics residing in the sensor plate can also be plugged to an electrical outlet. The monitoring system will periodically create messages to send to the cloud. These messages include volume, sensor readings, alerts. The periodicity of the messages is configurable by the users.

Users of the beverage monitoring system will be allowed to define thresholds for the volume and sensor readings such as battery voltage, humidity and temperature. If a reading or calculation exceeds its defined threshold, an alert is created. This alert is included in the periodic message that is sent to the cloud and/or local device. These messages will rely leverage encryption and security certificates for security.

The cloud and/or gateway services will receive and parse the periodic messages from the sensor plate. The cloud/gateway services will issue an acknowledgement that a message has been received. The readings and calculations are stored and will be used in the reports offered to the mobile form factor. The first check that the cloud/gateway services will do is to determine if there is an alert. If an alert is identified, this means that a threshold has been violated. An email will be sent to notify the designated recipient of the exception. The recipient of the email is designated by the user and is configurable. The email may instruct the user that the sensor plate may need to be recharged or the barrel may need to be replaced with a new, full barrel.

The following detailed description refers to the preferred embodiment of the invention, but there is no intention of restricting the invention to the preferred embodiment. The description is provided to encourage those skilled in the art to make and use this invention. Other embodiments can include a different size and varying dimensions of the sensor plate, different types of electronics or sensors, different sources of power, different type of cloud services and reporting services.

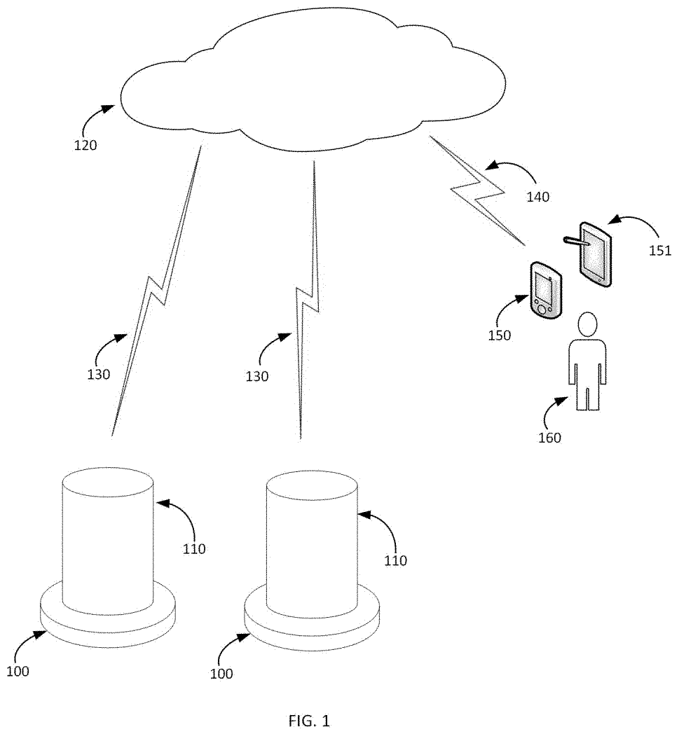

The automation system for tracking beverage consumption is displayed in FIG. 1. In this embodiment that tracking system is illustrated in default setting at an establishment where there are multiple sensor plates 100. The sensor plates 100 each have a keg 110 mounted on top of a respective plate. FIG. 1 showcases a connected establishment meaning that the establishment, and specifically, the sensor plates 100, can connect to the internet, namely the cloud service, 120. FIG. 1 showcases that the communications between cloud 120 and sensor plate 100 is bi-directional 130 meaning that messages are sent from the cloud 120 to the sensor plate 100 and from the sensor plate 100 to the cloud 120. The communications between the sensor plates 100 and the cloud 120 is encrypted for security. The messages sent from the sensor plates 100 to the cloud 120 consist of volume of the beverage in the barrel, environmental sensor readings, battery voltage readings and alerts in the case of violations of the threshold settings. The communications 130 from the cloud 120 to the sensor plates 100 consists of threshold settings and acknowledgements. The cloud 120 has application software services which provide capabilities for storing the volume, sensor readings and battery voltage readings and for processing alerts. The stored values are used for reports that will be furnished to the end user 160 using dashboards on mobile form factor devices such as a smartphone 150 and a tablet 151.

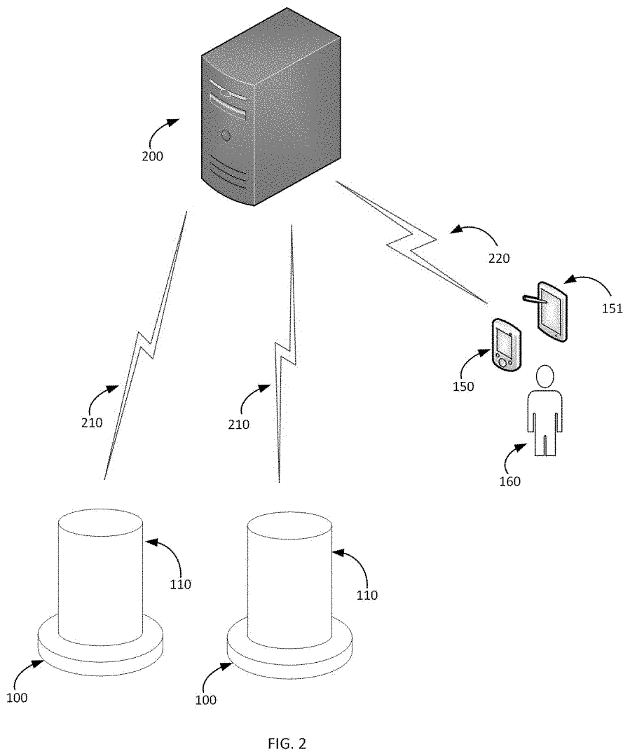

FIG. 2 showcases the embodiment of the automation system for tracking beverages in a environment that is connected locally within an establishment. This use case refers to establishments such as a bar on a cruise ship where the sensor plates 100 are connected to a local server or gateway 200. In this use case, the cloud services 120 are not readily available, so connectivity 210 is at the local level. The establishment has multiple barrels 110 each mounted on a respective sensor plate 100. The local server or gateway 200 exchanges encrypted bi-directional communications 210 with the sensor plates 100. The local server or gateway 200 transmits messages such as acknowledgements and threshold settings whereas the sensor plates 100 transmit messages such as alerts, battery voltage readings, sensor readings and volume calculations. The local server or gateway 200 will store the readings and volumes calculated as well as process the alerts. The stored values serve as the data source for the reports that the end user 160 will view using a user interface application on a device such as a smartphone 150 or tablet 151.

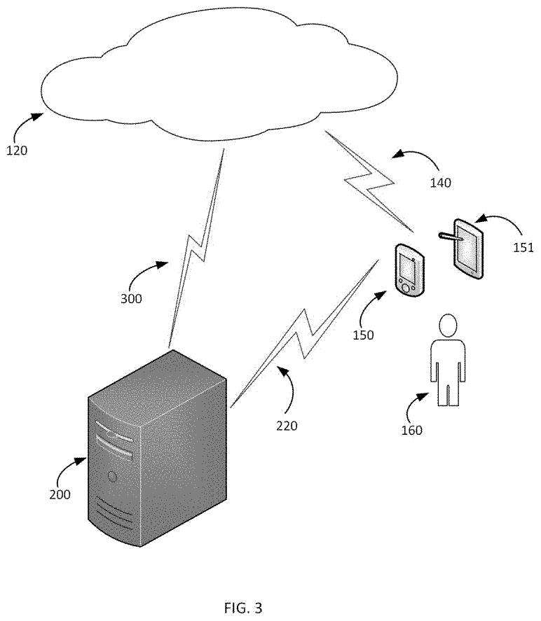

FIG. 3 depicts the use case of local gateway device 200 connecting to the cloud 120. This scenario represents the use case where the local gateway device 200 containing datasets that were stored locally has connectivity 300 to the cloud 120 and can transmit the locally stored datasets to the cloud 120. This use case is representative of a cruise ship having connectivity 300 when it docks at a port enabling the local gateway device 200 to have connectivity 300 to the cloud 120. FIG. 3 also demonstrates that the end user 160 will have access to both the cloud 120 and local gateway server 200 via bi-directional communications 140 and 220. The end user 160 will be able to view reports based on the datasets in the cloud 120 and in the local gateway device 200 via devices such as a smartphone 150 or tablet 151.

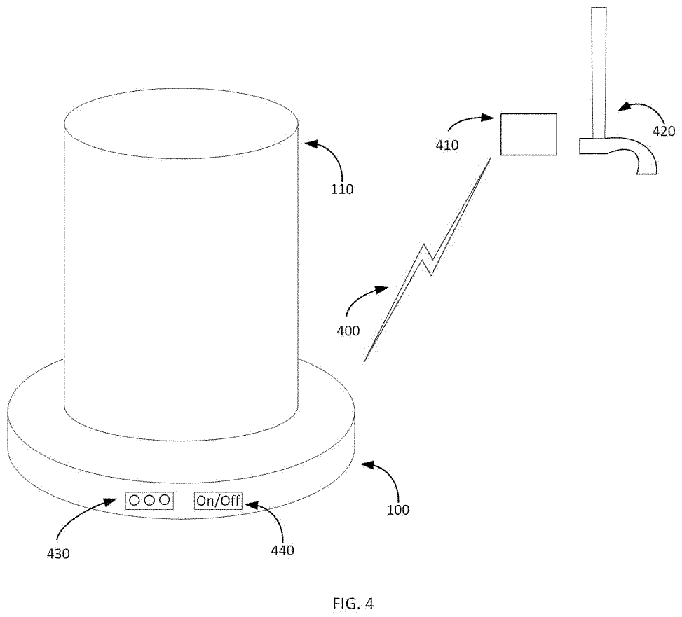

The sensor plate 100 is displayed in FIG. 4. The sensor plate 100 is illustrated with a barrel 110 situated on top of it. This embodiment showcases the real-time display 410 as a Liquid Crystal Display (LCD) that exhibits the real-time data points such as volume of the liquid in the keg, battery voltage or environmental readings. The display securely communicates 400 with the sensor plate 100 to obtain the real-time data values. In this embodiment, the LCD 410 is placed by the tap 420. The placement of this type of display is at the discretion of the user, such as the bartender. The data points on the LCD 410 are real-time unlike the user interface application on the mobile form factor which contains both historical data such as reports and real-time data. FIG. 4 also depicts the light indicators 430 that are mounted on the sensor plate. These light indicators 430 would allow the end user 160, such as a bartender, to visually inspect the barrels when inspecting the barrel cold storage without having to rely on the real-time display 410 by the beer dispenser or on a user interface application on a smartphone 150 or tablet 151. In this embodiment, the sensor plate 100 also has a switch 440 to power up and/or power down the plate.

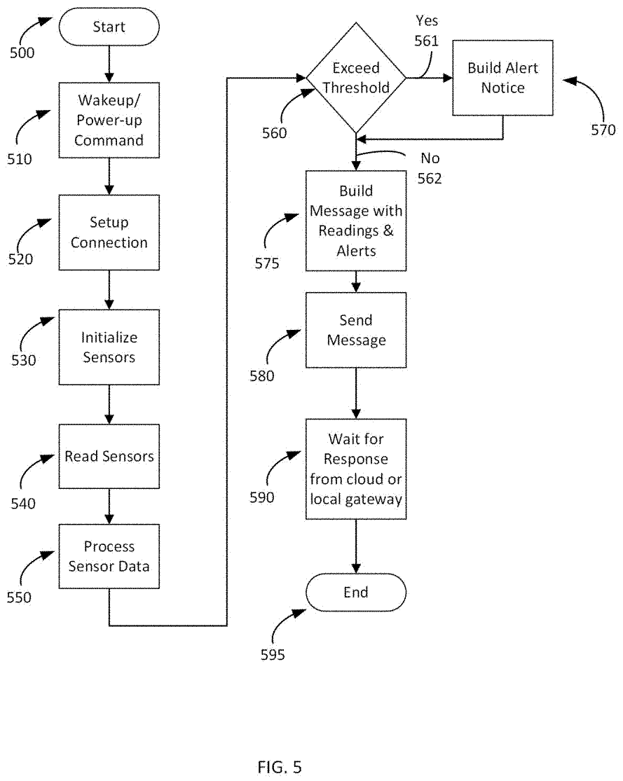

A software block diagram is shown in FIG. 5 to provide a high-level flowchart of the process that governs the sensor plate 100. This high-level process assumes that the sensor plate 100 is accepting commands. The process 500 begins when the sensor plate 100 receives a powering up command or wake up from a sleep command. Upon receiving a powering up command or sleep timeout command 510, the sensor plate 100 will initialize the communications to the cloud 120 or local server 200. After connectivity is initialized 520, the sensor plate 100 will then initialize its sensors 530. These sensors can be the weight sensor, battery voltage sensor and the environmental sensors. Once the sensors are initialized 530, the various sensors are queried 540. Upon receiving the process sensor command 550, the volume of the beverage in the barrel is calculated using the weight sensor data point. After reading the sensors 540 and processing the sensor data 550, the data readings and calculations are verified against the defined thresholds 560. If a reading or calculation exceeds its respective threshold 561, an alert notice is created 570. If the threshold is not exceeded 562, there is no need for an any alert notice. The sensor plate 100 will prepare a message 575 which includes the environmental sensor readings, battery voltage readings, volume calculations and any alerts. The message 580 is transmitted to the cloud 120 or local gateway 200. The application services in the cloud 120 and/or the local gateway server 200 will respond with an acknowledgement 590. The process in the sensor plate 100 then terminates 595. This termination 595 could be a sleep command or powering off command.

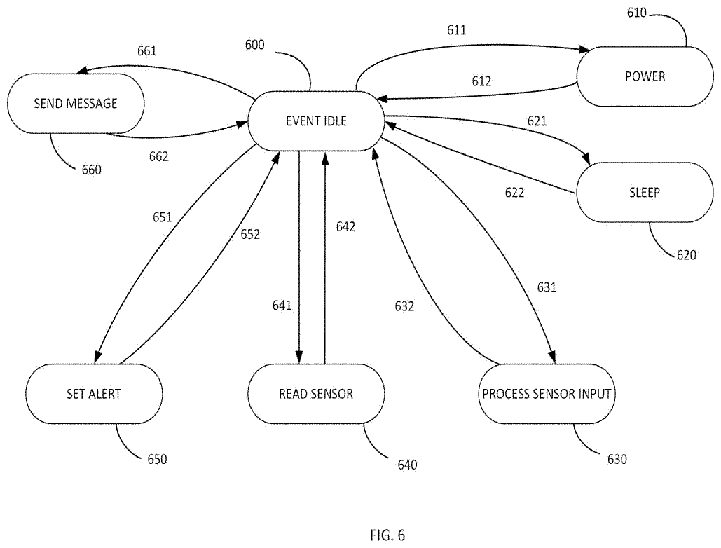

The finite state machine that models the software of the sensor plate 100 is depicted in FIG. 6. When the sensor plate 100 is POWERED ON 612, it enters the EVENT IDLE STATE 600. The sensor plate 100 can be powered up via a physical switch 440 located on the base of the sensor plate 100. The sensor plate's software is usually in the EVENT IDLE STATE 600 and changes to a different state depending on events. These events can be a read sensor command 641, process sensor input 631, alert condition 651, sleep command 621, send message command 661, or power command 611. If the software receives a read sensor command 641, it will enter the READ SENSOR STATE 640, and will issue a command acknowledgement 642. Examples of the read sensor commands can include reading the environmental sensors such as humidity and temperature, reading the battery voltage sensor, or reading the weight sensor. If the software receives a process sensor input event 631, the software enters the PROCESS SENSOR INPUT STATE 630 and will issue a process sensor input acknowledgement 632. The process sensor command 631 is issued in the sensor plate 100 to calculate the volume of the liquid in the barrel based on the weight reading. The process sensor input command 631 can be embedded in the acknowledgement of the read sensor input 642. If the software on the sensor plate 100 encounters an exception condition 651, it will enter the SET ALERT STATE 650 and an alert acknowledgement is issued 652. An example of an exception condition 651 could be the loss of connectivity to the cloud 120 or local gateway 200 or the battery voltage level is below a pre-defined threshold. The alert acknowledgement 652 will contain information on the type of exception. The alert acknowledgement 652 or process sensor input acknowledgement 632 can trigger a send message command 661. The sensor plate 100 enters the SEND MESSAGE STATE 660 when it receives a send message command 661. The SEND MESSAGE STATE 660 provides an acknowledgement 662. Another trigger event to the sensor plate 100 would be a power off command 611 and the sensor plate 100 will acknowledge a shutdown command 612 and then proceed to power itself down and enter the POWER OFF STATE 610. In one embodiment, the sensor plate 100 also has a SLEEP STATE 620. The SLEEP STATE 620 is a low-power state meaning that the sensor plate 100 is utilizing less power than during normal operations. When the sensor plate 100 receives a sleep command 621, the sensor plate 100 will acknowledge with a sleep acknowledgement 622 and proceed to the SLEEP STATE 620. From the SLEEP STATE 620, the sensor plate 100 can enter the EVENT IDLE STATE 600 with a sleep acknowledgement 622. The sleep timeout is embedded in the sleep acknowledgement 622.

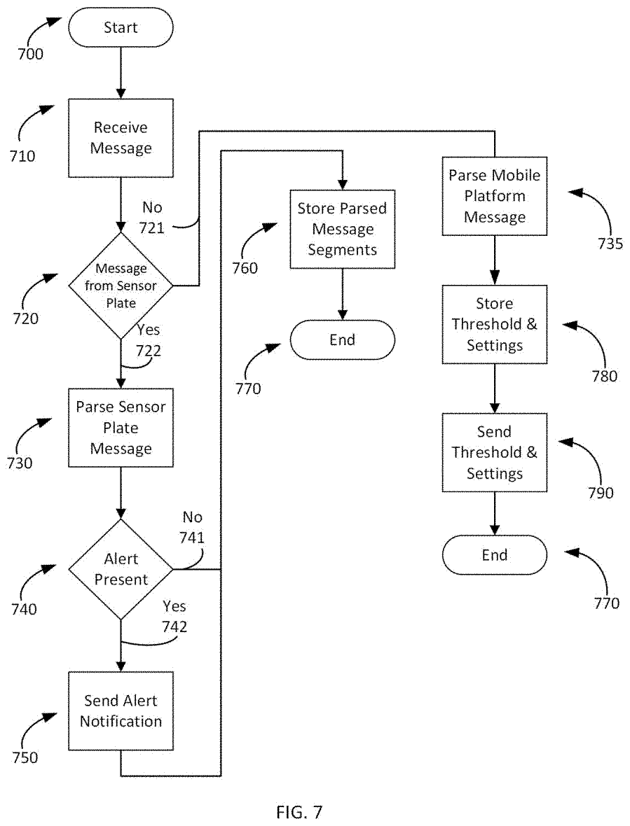

FIG. 7 is a high-level flow diagram of the cloud application and local gateway application. The application is essentially the same. The difference is where it is resides either on the cloud 120 or locally on a gateway server 200. The application 700 begins when a message is received 710. The process needs to determine if the incoming message 710 came from the sensor plate 100 or from the user interface of the mobile form factor. If the received message 720 came from the sensor plate 100, then the message 722 is parsed according to the sensor plate message format 730. The sensor plate message 720 is inspected to determine if an alert exists which indicates that the threshold was exceeded 740. If the incoming message from the sensor plate 100 includes an alert 742, a notification of the alert is created and sent 750. One embodiment of this notification 750 can be an email to a bar manager or bartender. The parsed elements of the received message 710 from the sensor plate 100 are stored 760 and the processing of the incoming sensor plate message ends 770. These stored elements can be used for dashboards and reports on the mobile form factor device. If the received message that is being processed was sent by the mobile device 721, then the message is parsed based on the format pertaining to the mobile form factor 735. The messages from the mobile form factor contain thresholds and settings and must be stored 780. A message containing the settings and thresholds is created 790 and sent to sensor plate 100. The process ends 770 upon the transmission of the message.

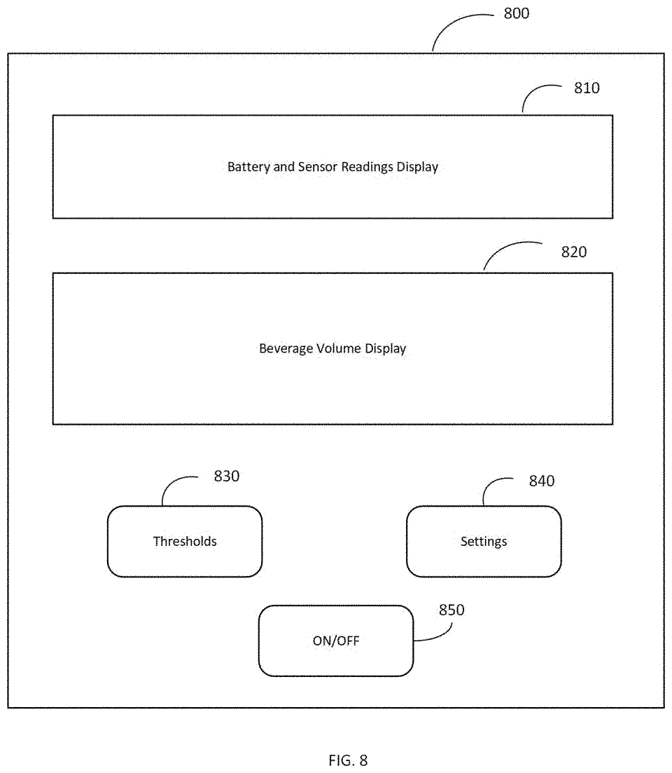

An embodiment of the automation system for tracking beverage consumption includes having an application on a smartphone 150 or tablet 151. The user interface for the mobile phone factor consists of dashboards that are configurable. FIG. 8 depicts one embodiment of the user interface 800. This embodiment has a display dashboard pane for the sensor readings and battery voltage 810. This readings-display pane is configurable. The user 160 may opt to showcase the readings as gauges or numerical values. The display of the volume calculation of the beverage in the barrel 820 is also another display pane in this embodiment. The beverage volume display pane 820 is configurable, and the user 160 can decide to display the volume as percentages, numerical values or gauges. The application on the mobile form factor also offers the user 160 the ability to input data such as thresholds and settings through the Threshold Control button 830 and the Settings Control button 840. The Threshold Control button 830 will let the user 160 define the thresholds for volume, environmental sensors, and battery voltage. The Settings Control button 840 will let the user 160 select and configure connectivity settings.

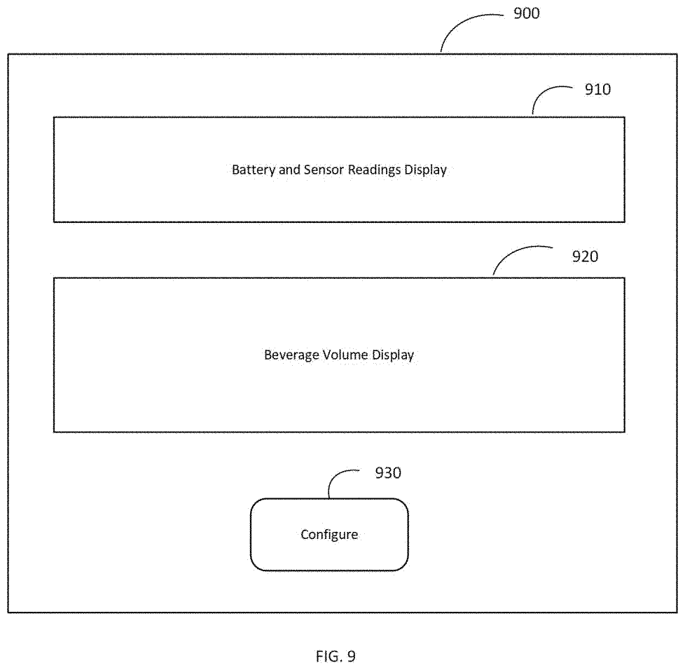

FIG. 9 depicts an embodiment of the user interface of the real-time display 900. A possible embodiment is using an LCD. The real-time display 900 has a pane 910 for displaying readings such as battery voltage and environmental sensor readings. The volume of the liquid contained in the barrel 110 is displayed in the beverage volume pane 920. The battery and sensor readings display 910 and the beverage volume display 920 are configurable by selecting the Configure control button 930. The displays can showcase the volume, battery, and sensor readings as gauges, numerical values, and/or percentages. The configuration is at the discretion of the user 160 such as the bartender.

The forgoing description is exemplary embodiments of the invention so a person skilled in the art would be capable of recognizing from the figures, claims, and descriptions that changes could be made to the preferred embodiments without departing from the scope of the invention as defined by the following claims.

What is claimed:

1. An automation system for tracking beverage consumption comprising:
a sensing mechanism disposed within its base to measure liquids stored in a barrel;
a sensor plate;
a housing for electronics such as sensors;
a housing for mechanical sensors such as strain gauges;
electronic sensors to monitor environmental conditions such as temperature and humidity;
electronic communications transceivers;
battery;
battery charger;
micro-processing system;
real-time display;
light indicators;
cloud-based service application;
local service application;
a user interface.

2. The automation system of claim 1, wherein contains a sensor plate where the barrel is placed. This sensor plate will be able to measure weight of barrel filled with liquid having a combined weight of up to 100 Kg.

3. The automation system of claim 2, wherein the sensor plate has a housing for electronics for measuring the weight of the liquid contained in the barrel situated on top of the sensor plate.

4. The automation system of claim 2, wherein the sensor plate has a micro-processing system to translate weight readings to volume calculations.

5. The automation system of claim 2, wherein the sensor plate has housing for electronics for monitoring and storing battery voltage.

6. The automation system of claim 2, wherein the sensor plate has housing for electronics for monitoring environmental conditions such as temperature and humidity.

7. The automation system of claim 2, wherein the sensor plate has housing for electronics such as transceivers for transmitting alerts, sensor readings and volume calculations to the cloud or other local service and for receiving acknowledgements and thresholds.

8. The automation system of claim 2, wherein sensor plate has housing for electronics for monitoring and storing battery voltage.

9. The automation system of claim 1, where contains a battery charger to restore battery voltage to an operational threshold.

10. The automation system of claim 1, wherein the cloud-based application configures the connectivity to the cloud-based application and/or local application service, defines initial threshold settings for the sensors, and configures the calibration settings for the weight calculations.

11. The automation system of claim 1, wherein the cloud-based application service to process messages from the sensor plate, handles alerts, provides acknowledgments, transmits desired thresholds.

12. The automation system of claim 1, wherein the local application service configures the connectivity to the cloud-based application and/or local application service, defines initial threshold settings for the sensors, and configures the calibration settings for the weight calculations.

13. The automation system of claim 1, wherein the local server application service to process messages from the sensor plate, handles alerts, provides acknowledgments, transmits desired thresholds.

14. The automation system of claim 1, wherein the user interface application service that resides in a mobile form factor which provides reports based on the datasets stored at the cloud or locally.

15. The automation system of claim 1, wherein the real-time display provides real-time data points such as current volume calculations, environmental sensor readings and battery voltage level for a given barrel mounted on a given sensor plate.
